(19) United States
(12) Patent Application Publication
(10) Pub. No.: US 2014/0214437 A1
(43) Pub. Date: Jul. 31, 2014

(54) MEDICAL ADVISORY SYSTEM

(71) Applicants: Joshua M. Ammerman, Bethesda, MD (US); Matthew D. Ammerman, Bethesda, MD (US)

(72) Inventors: Joshua M. Ammerman, Bethesda, MD (US); Matthew D. Ammerman, Bethesda, MD (US)

(21) Appl. No.: 14/164,911

(22) Filed: Jan. 27, 2014

Related U.S. Application Data
(60) Provisional application No. 61/757,523, filed on Jan. 28, 2013.

(51) Int. Cl. G06F 19/00

(52) U.S. Cl. CPC G06F 19/3418
USPC 705/2

(57) ABSTRACT

A method and computer program product is provided for a medical advisory system. The method may include receiving an anonymous request for a medical opinion by a user. The method may also include providing the anonymous request for the medical opinion to at least one anonymous medical professional. The method may further include receiving an anonymous response associated with the anonymous request for the medical opinion based upon, at least in part, review of the anonymous request for the medical opinion by the at least one anonymous medical professional. The method may also include providing the anonymous response associated with the anonymous request for the medical opinion to the user.

### CROSS-REFERENCE TO RELATED APPLICATION

This application claims the benefit of U.S. Provisional Application Ser. No. 61/757,523, filed 28 Jan. 2013, of which the entire contents are incorporated herein reference.

### TECHNICAL FIELD

This disclosure relates to a medical advisory service and, more particularly, to an internet-based medical advisory system.

### BACKGROUND

A large number of people seek additional medical input prior to making significant medical decisions. This is largely accomplished by scheduling in-person appointments with physicians to present their history, be examined, and request that the provider review available medical tests and imaging studies. Such appointments are costly, may not be covered by insurance, and may often require a long wait time of days to weeks. This delay may have negative implications for the health of individuals in search of more guidance. Many individuals seeking this additional information are simply looking for confirmation of their intended plan, thus making the delay undesirable.

### SUMMARY OF DISCLOSURE

According to an implementation, a method may include receiving, at the one or more computing devices, an anonymous request for a medical opinion by a user. The method may also include providing, using the one or more computing devices, the anonymous request for the medical opinion to at least one anonymous medical professional. The method may further include receiving, at the one or more computing devices, an anonymous response associated with the anonymous request for the medical opinion based upon, at least in part, review of the anonymous request for the medical opinion by the at least one anonymous medical professional. The method may also include providing, using the one or more computing devices, the anonymous response associated with the anonymous request for the medical opinion to the user.

One or more of the following features may be included. The anonymous request for the medical opinion may include an inquiry associated with a medical condition.

Receiving the anonymous request for the medical opinion may include receiving medical records associated with the anonymous request for the medical opinion. The medical records associated with the anonymous request for the medical opinion may include at least one of: at least one symptom, a medical history, a current diagnosis, an existing treatment plan, at least one medical test result, and at least one medical image. At least one of the at least one medical test and the at least one medical image may include user identifying demographic data.

The method may further include obfuscating the user identifying demographic data within at least one of the at least one medical test result and the at least one medical image.

The anonymous response associated with the anonymous request for the medical opinion may include at least one of: a proposed diagnosis, a proposed treatment, and educational information associated with the anonymous request for the medical opinion.

The method may also include deleting the medical records associated with the anonymous request for the medical opinion after providing the anonymous response associated with the anonymous request for the medical opinion to the user.

The at least one anonymous medical professional may be included within a panel of a plurality of identified medical professionals. The at least one anonymous medical professional may specialize in the medical condition.

In another implementation, a computer program product resides on a computer readable medium and has a plurality of instructions stored on it. When executed by a processor, the instructions cause the processor to perform operations including receiving an anonymous request for a medical opinion by a user. The instructions may also include providing the anonymous request for the medical opinion to at least one anonymous medical professional. The instructions may further include receiving an anonymous response associated with the anonymous request for the medical opinion based upon, at least in part, review of the anonymous request for the medical opinion by the at least one anonymous medical professional. The instructions may also include providing the anonymous response associated with the anonymous request for the medical opinion to the user.

One or more of the following features may be included. The anonymous request for the medical opinion may include an inquiry associated with a medical condition.

Receiving the anonymous request for the medical opinion may include receiving medical records associated with the anonymous request for the medical opinion. The medical records associated with the anonymous request for the medical opinion may include at least one of: at least one symptom, a medical history, a current diagnosis, an existing treatment plan, at least one medical test result, and at least one medical image. At least one of the at least one medical test and the at least one medical image may include user identifying demographic data.

The instructions may further include obfuscating the user identifying demographic data within at least one of the at least one medical test result and the at least one medical image.

The anonymous response associated with the anonymous request for the medical opinion may include at least one of: a proposed diagnosis, a proposed treatment, and educational information associated with the anonymous request for the medical opinion.

The instructions may also include deleting the medical records associated with the anonymous request for the medical opinion after providing the anonymous response associated with the anonymous request for the medical opinion to the user.

The at least one anonymous medical professional may be included within a panel of a plurality of identified medical professionals. The at least one anonymous medical professional may specialize in the medical condition.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a computing network including a computing device that executes a medical opinion process;

FIG. 2 is a diagrammatic view of a flowchart depicting operations consistent with an embodiment of the medical opinion process of FIG. 1;

FIG. 3 is diagrammatic representation of an example medical opinion process of FIG. 1, according to an implementation of the present disclosure;

FIG. 4 is diagrammatic representation of an example medical opinion process of FIG. 1, according to an implementation of the present disclosure;

FIG. 5 is diagrammatic representation of an example medical opinion process of FIG. 1, according to an implementation of the present disclosure;

FIG. 6 is diagrammatic representation of an example medical opinion process of FIG. 1, according to an implementation of the present disclosure;

FIG. 7 is diagrammatic representation of an example medical opinion process of FIG. 1, according to an implementation of the present disclosure;

FIG. 8 is diagrammatic representation of an example medical opinion process of FIG. 1, according to an implementation of the present disclosure;

FIG. 9 is diagrammatic representation of an example medical opinion process of FIG. 1, according to an implementation of the present disclosure;

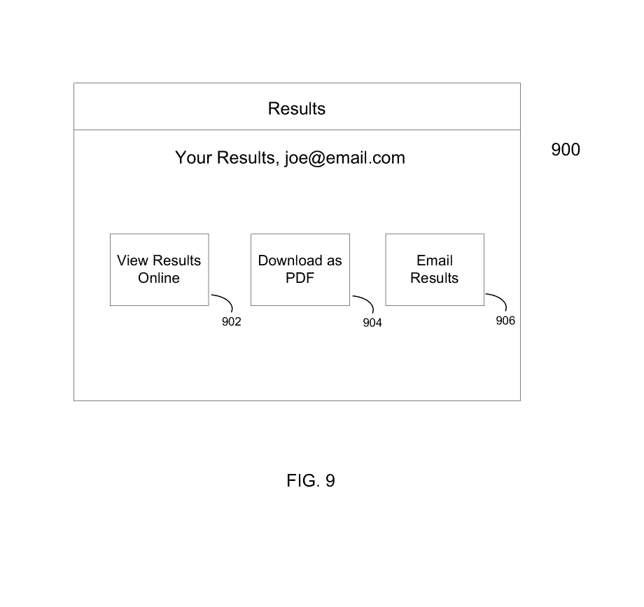

Like reference symbols in the various drawings may indicate like elements.

### DETAILED DESCRIPTION

### System Overview:

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C⁺⁺ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

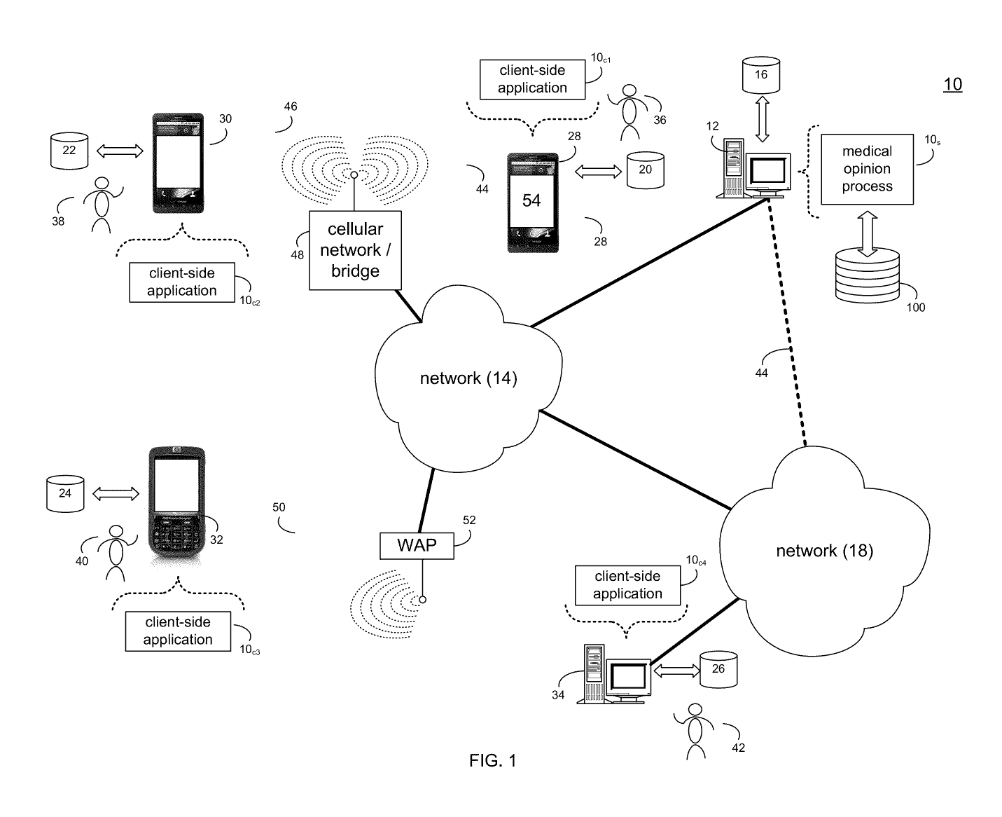

Referring to FIG. 1, there is shown medical opinion process 10. Medical opinion process 10 may be implemented as a server-side process, a client-side process, or a hybrid server-side/client-side process. For example, medical opinion process 10 may be implemented as a purely server-side process via medical opinion process 10s. Alternatively, medical opinion process 10 may be implemented as a purely client-side process via one or more of client-side application 10c1, client-side application 10c2, client-side application 10c3, and client-side application 10c4. Alternatively still, medical opinion process 10 may be implemented as a hybrid server-side/client-side process via medical opinion process 10s and a combination of one or more of client-side application 10c1, client-side application 10c2, client-side application 10c3, and client-side application 10c4. Accordingly, medical opinion process 10 as used in this disclosure may include any combination of medical opinion process 10s, client-side application 10c1, client-side application 10c2, client-side application 10c3, and client-side application 10c4.

Medical opinion process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a server computer, a series of server computers, a mini computer, a mainframe computer, or a dedicated network device.

The instruction sets and subroutines of medical opinion process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, or a specialized application (e.g., a game application running on a platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephones 28, 30, personal digital assistant 32, personal computer 34, a laptop computer (not shown), a notebook computer (not shown), a server computer (not shown), a gaming console (not shown), and a dedicated network device (not shown).

Users 36, 38, 40, 42 may access medical opinion process 10 directly through network 14 or through secondary network 18. Further, medical opinion process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephones 28, 30 are shown wirelessly coupled to network 14 via wireless communication channels 44, 46 (respectively) established between data-enabled, cellular telephones 28, 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 28, 30, 32, 34 may each execute an operating system, examples of which may include but are not limited to Microsoft Windows™, Android™, WebOS™, iOS™, Redhat Linux™, or a custom operating system.

### Medical Opinion Process:

Medical opinion process 10 may control/include and be coupled to database 100. Medical opinion process 10 may allow various users to anonymously request a medical opinion associated with a medical condition from at least one anonymous medical professional. The anonymous request may be stored within database 100. An example of database 100 may include but is not limited to a centralized, web-based database such as those available by Oracle™, Microsoft™, Google™, etc. Database 100 may be accessible via client electronic devices 28, 30, 32, 34 using one or more of client-side application 10c1, client-side application 10c2, client-side application 10c3, and client-side application 10c4. Accordingly, one or more of users 36, 38, 40, 42 (respectively) may review anonymous responses saved within database 100 via a web-based application.

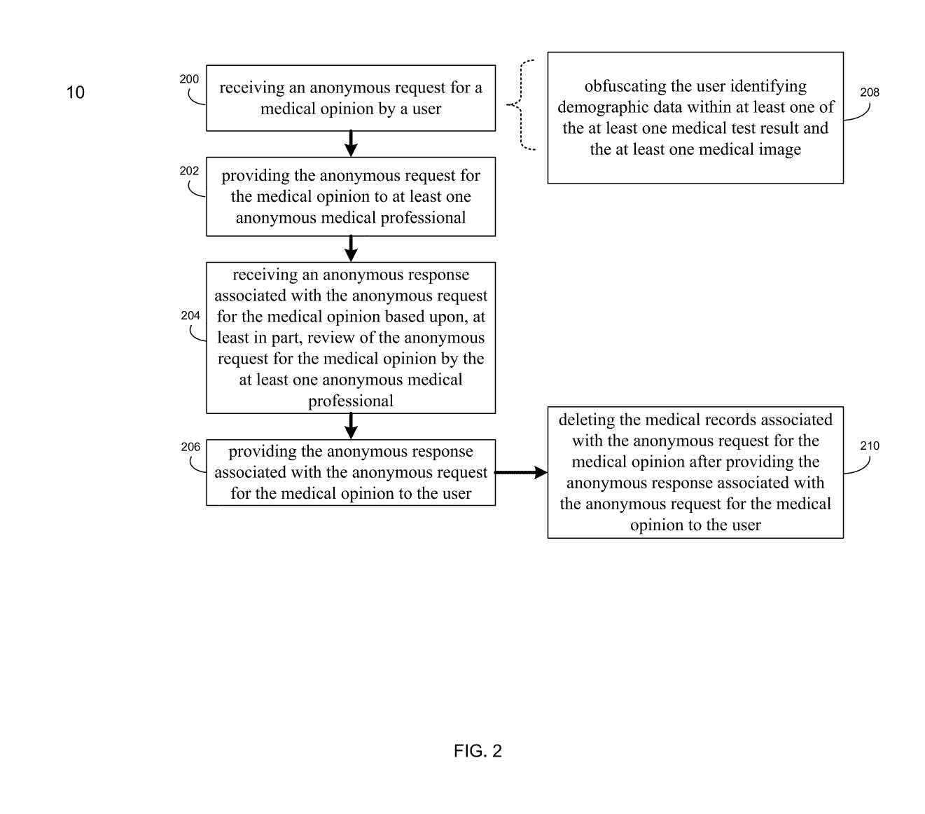

With reference to FIG. 2, medical opinion process 10 may receive 200 an anonymous request for a medical opinion by a user. Medical opinion process 10 may also provide 202 the anonymous request for the medical opinion to at least one anonymous medical professional. Medical opinion process 10 may also receive 204 an anonymous response associated with the anonymous request for the medical opinion based upon, at least in part, review of the anonymous request for the medical opinion by the at least one anonymous medical professional. Medical opinion process 10 may further provide 206 the anonymous response associated with the anonymous request for the medical opinion to the user.

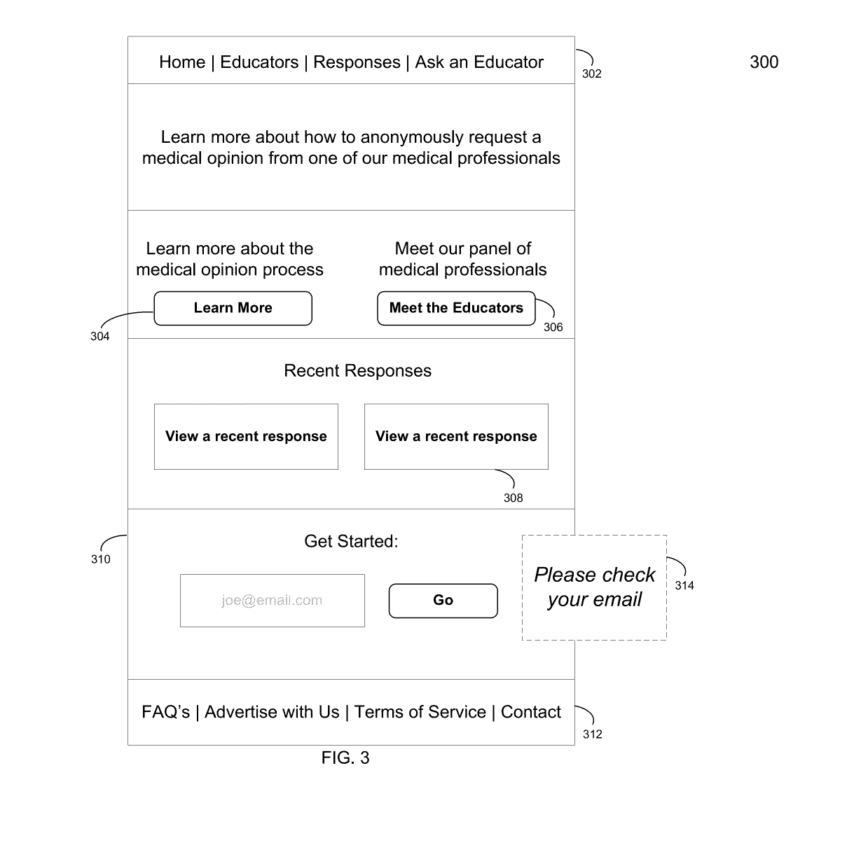

In an embodiment, medical opinion process 10 may receive 200 an anonymous request for a medical opinion by a user. Medical opinion process 10 may receive the anonymous request for the medical opinion from operating client electronic device 34 associated with user 42 over network 14, 18. As shown in FIG. 3, a user interface via a web-based application may include landing page 300 to introduce the user to the medical opinion service, including but not limited to, how the service works, what to expect, example medical opinions, and the like. For example, landing page 300 may include primary navigation 302, a link to learn more about the medical opinion service (e.g., “Learn More” 304), a link to meet the medical professionals (e.g., “Meet the Educators” 306), at least one link to a recent response (e.g., “View a recent response” 308), an input to get started (e.g., “Get Started” 310), and footer navigation 312. This is for illustrative purposes only and is not intended to be a limitation of this disclosure as landing page 300 may be configured in accordance with the objectives of an administrator (not shown) of medical opinion process 10 or using any suitable approach.

Medical opinion process 10 may receive a user input via “Get Started” 310. User input may include any user based information, such as an email address associated with the user (e.g., user 42). The user email address may be an anonymous email address such that the user may not be identified by name. Upon submission, pop-up window 314 may be provided requesting that the user check his or her email. Medical opinion process 10 may send a confirmation email (not shown) to the user to confirm the email address associated with the user. In some embodiments, confirmation email (not shown) may include a link to redirect the user to a separate page associated with the web-based application to begin submitting an anonymous request for a medical opinion. For example, the link from confirmation email may redirect user 42 to a non-indexed page of the web-based application to allow user 42 to begin submitting the anonymous request for the medical opinion.

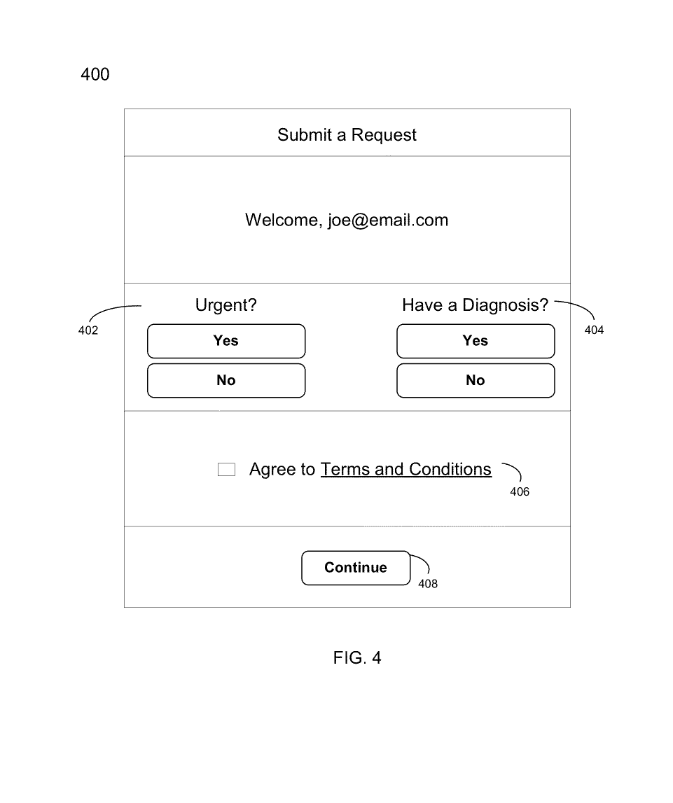

Referring to FIG. 4, medical opinion process 10 may redirect user 42 from the confirmation email to welcome page 400. Welcome page 400 may include a series of screening questions to determine is a medical condition is routine or requires immediate medical attention. As shown in FIG. 4, welcome page 400 may include at least one question and an input field for user 42 to specify whether the anonymous request for the medical opinion is urgent (e.g., “Urgent?” 402). If the anonymous request for the medical opinion is urgent, medical opinion process 10 may redirect user 42 to an emergency screen (not shown) to inform user 42 to seek immediate treatment at a hospital emergency room immediately.

The anonymous request for the medical opinion may include an inquiry associated with a medical condition. For example, welcome page 400 may include at least one question referring to a current diagnosis (e.g., “Have a Diagnosis?” 404) of a medical condition and an input field to allow user 42 to provide a response associated with the current diagnosis and medical condition. Based upon a received response, medical opinion process 10 may determine whether user 42 has a current diagnosis from a treating physician. If user 42 does not have a current diagnosis from a treating physician, medical opinion process 10 may prompt user 42 that the medical opinion service is an educational tool and may not take the place of visiting a physician for a diagnosis first.

Welcome page 400 may also include an input field to indicate that user 42 has read the Terms and Conditions (e.g., Terms and Conditions 406). Terms and Conditions 406 may be linked to a separate page (not shown) with a listing of the Terms and Conditions of the web-based application. If the anonymous request for the medical opinion is not urgent, a current diagnosis exists, and user 42 agrees to the Terms and Conditions, user 42 may continue with the anonymous request for the medical opinion by selecting “Continue” button 408.

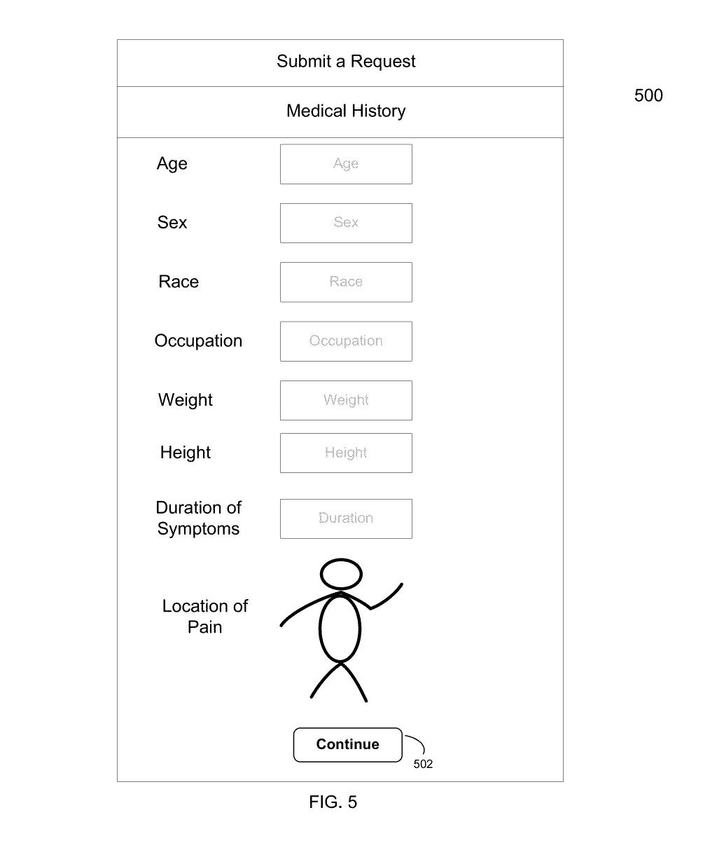

In an embodiment, receiving 200 the anonymous request for the medical opinion may include receiving medical records associated with the anonymous request for the medical opinion. The medical records associated with the anonymous request for the medical opinion may include at least one of: at least one symptom, a medical history, a current diagnosis, an existing treatment plan, at least one medical test result, and at least one medical image. Referring to FIG. 5, medical opinion process 10 may provide medical history form 500 to receive medical records associated with the anonymous request for the medical opinion from the user. For example, as shown in FIG. 5, medical opinion process 10 may request various information regarding general medical history, including, but not limited to, age, sex, race, occupation, height, weight, symptoms, duration of symptoms, location of pain, location of weakness, and location of tingling and/or numbness. Medical opinion process 10 may provide checkboxes, dropdown boxes, radio buttons, freeform fields, and any other response input field appropriate to receive user inputs associated with each form field provided on medical history form 500. Particular questions may be required based upon the objectives of the administrator (not shown) of medical opinion process 10. Medical history form 500 may include a mechanism to allow user 42 to continue with the anonymous request for the medical opinion (e.g., via “Continue” button 502).

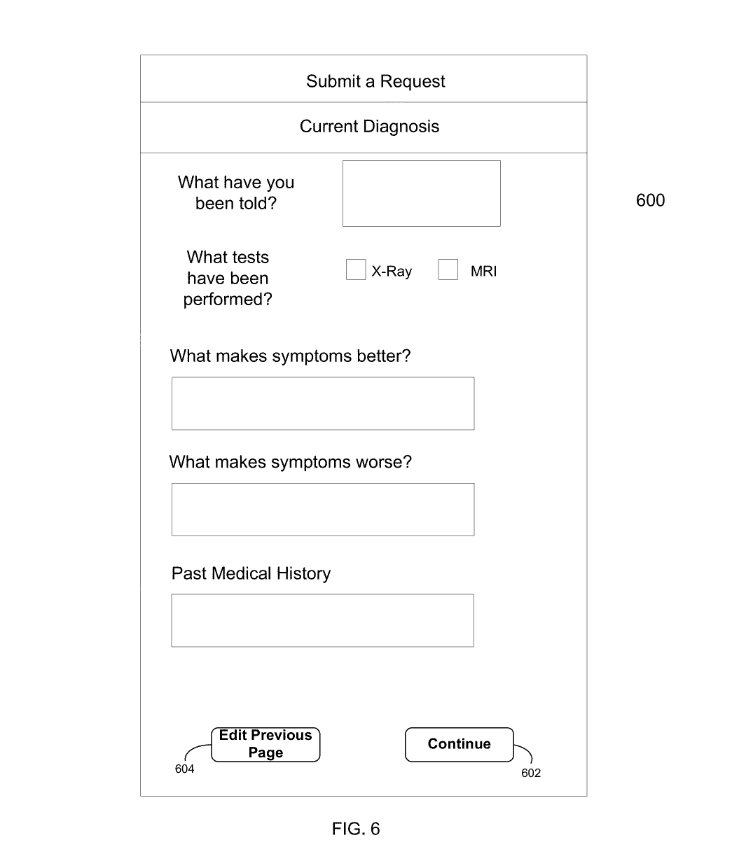

In an embodiment and referring to FIG. 6, upon completion of medical history form 500, medical opinion process 10 may direct user 42 to current diagnosis form 600. Medical opinion process 10 may request user 42, via current diagnosis form 600, to share information specific to the current diagnosis and medical condition. Medical opinion process 10 may dynamically generate current diagnosis form 600 based upon received responses from medical history form 500. Information requested via current diagnosis page 600 may differ based upon the received responses from medical history form 500. Medical opinion process 10 may request various information from user 42 via current diagnosis form 600, including, but not limited to, existing treatment recommendations from an existing physician, tests that have already been performed, history of diagnostic tests, what make the symptoms worse, what makes the symptoms better, and past medical history. Medical opinion process 10 may provide checkboxes, dropdown boxes, radio buttons, freeform fields, and any other response input field appropriate to receive user inputs associated with each form field provided on current diagnosis form 600. Particular questions may be required based upon the objectives of the administrator (not shown) of medical opinion process 10. Current diagnosis form 600 may include a mechanism to allow user 42 to continue with the anonymous request for the medical opinion (e.g., “Continue” button 602). Current diagnosis form 600 may also allow the user to edit the medical history, for example, “Edit Previous Page” button 604 may allow user 42 to edit medical history form 500.

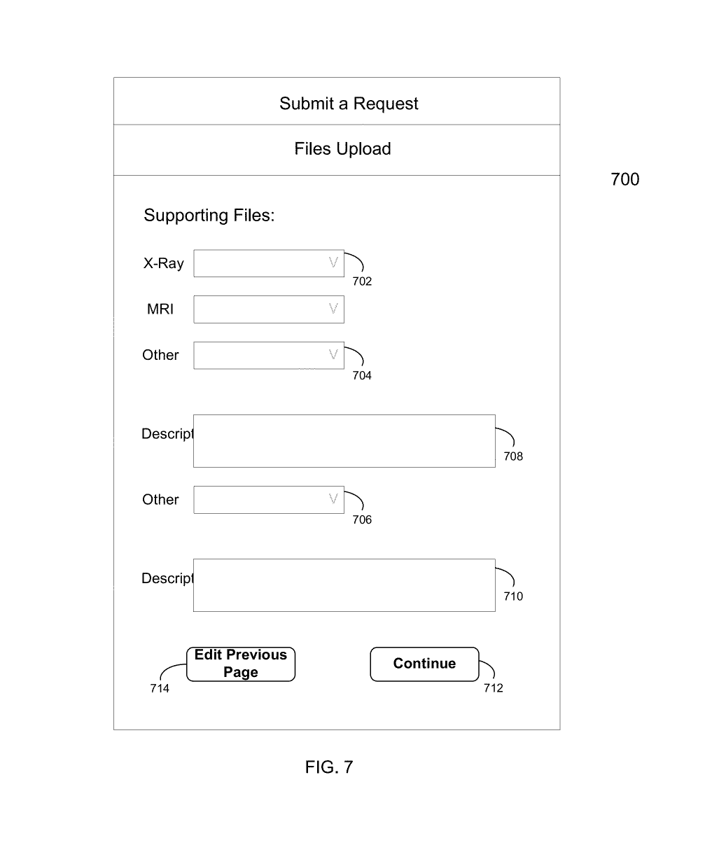

In an embodiment and referring to FIG. 7, upon completion of medical diagnosis form 600, medical opinion process 10 may direct user 42 to files upload form 700. Medical opinion process 10, via files upload form 700, may provide an ability to upload files containing digital images and other medical records associated with the anonymous request for the medical opinion. Medical opinion process 10 may dynamically generate specific file uploads based upon received responses from medical diagnosis form 600. For example, if user 42 indicated that an X-ray was previously performed in medical diagnosis form 600, medical opinion process 10 may dynamically generate X-ray field 702. In addition, files upload form 700 may include additional generic file upload fields 704, 706 and description fields 708, 710. Multiple files and/or whole directories may be uploaded via files upload form 700, including at least one medical test result and/or at least one medical image. Medical imaging may be used to create images of the human body for clinical purposes and may include any biological imaging. Examples of medical test results and medical images may include, but are not limited to, an X-ray image, a computed tomography (CT) scan result, an ultrasound image, magnetic resonance imaging (MRI) results, blood test results, and any other result from a medical test and/or medical imaging technique. Files upload form 700 may include “Continue” button 712 to allow user 42 to upload the at least one medical test result and/or at least one medical image and continue with the anonymous request for the medical opinion. Files upload form 700 may also include “Edit Previous Page” button 714 to allow user 42 to edit medical diagnosis form 600 and/or medical history form 500.

In an embodiment, at least one of the at least one medical test result and the at least one medical image may include user identifying demographic data. User identifying demographic data may include, but is not limited to, name of the patient associated with the file, age of the patient associated with the file, date of birth of the patient associated with the file, etc. User identifying demographic data may be applied as an overlay to electronic images at the time of production.

Medical opinion process 10 may obfuscate 208 the user identifying demographic data within at least one of the at least one medical test result and the at least one medical image. Obfuscating 208 the user identifying demographic data may include removing the overlay from each medical test result and medical image uploaded. Obfuscating 208 the user identifying demographic data may also include covering the user identifying demographic data with a “black box” that may not be removed. Any obfuscating techniques may be employed to obfuscate the user identifying demographic data. Medical opinion process 10 may identify a location for any user identifying demographic data on each medical test result and medical image while uploading and may obfuscate 208 the user identifying demographic data accordingly. In some embodiments, obfuscating may include removing and/or deleting some or all of the user identifying demographic data.

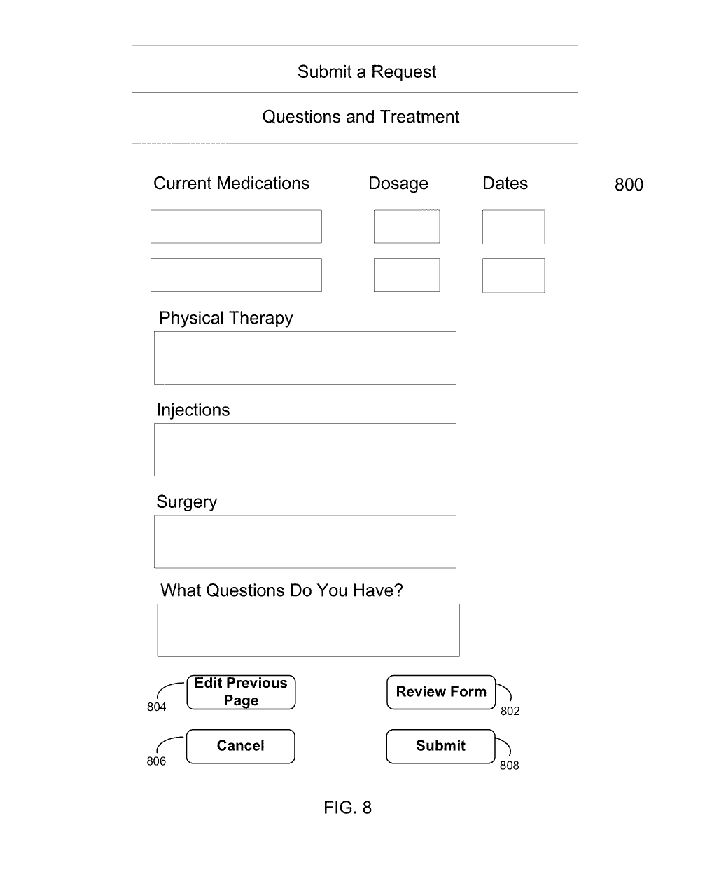

In an embodiment and referring to FIG. 8, upon completion of files upload form 700, medical opinion process 10 may direct user 42 to questions and treatment page 800. Questions and treatment page 800 may provide user 42 with an opportunity to inquire about the medical condition or current diagnosis and enter any specific questions user 42 may have regarding the medical condition, current diagnosis, or treatment. Medical opinion process 10 may request information via questions and treatment page 800 regarding current treatments, including, but not limited to current medications, physical therapy, injections, and past surgeries. Medical opinion process 10 may provide checkboxes, dropdown boxes, radio buttons, freeform fields, and any other response input field appropriate to receive user inputs associated with each form field provided on questions and treatment page 800. Particular information may be required based upon the objectives of the administrator (not shown) of medical opinion process 10. Questions and treatment page 800 may include “Review Form” button 802 to allow user 42 to review the completed form and may include “Edit Previous Page” 804 to allow user 42 to edit medical diagnosis form 600, medical history form 500, and/or files upload form 700.

In operation, upon clicking “Review Form” button 802, medical opinion process 10 may direct user 42 to a submission review page (not shown). The submission review page (not shown) may display the received responses from medical history form 500, medical diagnosis form 600, files upload form 700, and questions and treatment page 800. Submission review page (not shown) may include an option for user 42 to edit or delete any of the medical records, data, and information received from medical history form 500, medical diagnosis form 600, files upload form 700, and questions and treatment page 800.

Questions and treatment page 800 may further include an option to allow the anonymous request for the medical opinion to display an anonymous response associated with the anonymous request for the medical opinion to be publicly displayed on the web-based application. Questions and treatment page 800 may further include an option to cancel the anonymous request (e.g., “Cancel” 806) and submit the anonymous request for the medical opinion including all of the submitted medical records (e.g., “Submit” 808). Once submitted, the anonymous request for the medical opinion, medical records, and received responses from medical history form 500, medical diagnosis form 600, files upload form 700, and questions and treatment page 800 may be saved to database 100. The request may be saved anonymously, without any identifying information of user 42.

In an embodiment, medical opinion process 10 may provide 202 the anonymous request for the medical opinion to at least one anonymous medical professional. Medical opinion process 10 may provide 202 the anonymous request for the medical opinion from operating client electronic device 34 associated with user 42 over network 14, 18 to an operating client electronic device (e.g., operating client electronic device 28, 30, 32) associated with at least one anonymous medical professional (e.g., user 36, 38, 40). The at least one anonymous medical professional may specialize in the medical condition. That is, the at least one anonymous medical professional may specialize in the medical condition associated with the anonymous request for the medical opinion. Medical opinion process 10 may determine at least one anonymous medical professional that specializes in the medical condition and may provide 202 the anonymous request for the medical opinion to the at least one anonymous medical professional that specializes in the inquired medical condition.

The at least one anonymous medical professional may be included within a panel of a plurality of identified medical professionals. Medical opinion process 10 may allow users to browse the plurality of identified medical professionals and review the professional data associated with each identified medical professional. For example, referring to FIG. 3, landing page 300 may include a link to meet the medical professionals (e.g., “Meet the Educators” 306). “Meet the Educators” 306 may redirect user 42 to a separate page (not shown) listing each medical professional available to review the received 200 anonymous request for the medical opinion by user 42. The listing of medical professionals available to review the received anonymous request may include professional data associated with each medical professional, including, but not limited to, name, education, experience, specialization, etc.

At least one of the plurality of identified medical professionals may review the provided anonymous request for the medical opinion. The provided anonymous request for the medical opinion may include the received responses from medical history form 500, medical diagnosis form 600, files upload form 700, and questions and treatment page 800, as discussed above. Upon review, the at least one of the plurality of identified medical professionals may anonymously provide a response associated with the anonymous request for the medical opinion.

Medical opinion process 10 may further receive 204 an anonymous response associated with the anonymous request for the medical opinion based upon, at least in part, review of the anonymous request for the medical opinion by the at least one anonymous medical professional. Medical opinion process 10 may receive 204 anonymous response associated with the anonymous request for the medical opinion from operating client electronic device (e.g., operating client electronic device 28, 30, 32) associated with the at least one anonymous medical professional (e.g., user 36, 38, 40). While the panel of plurality of identified medical professionals may be identified, the identity of the medical professional that provided the response associated with the anonymous request for the medical opinion may remain anonymous.

The anonymous response associated with the anonymous request for the medical opinion may include, but are not limited to, at least one of: a proposed diagnosis, a proposed treatment, and educational information associated with the anonymous request for the medical opinion. The anonymous response associated with the anonymous request for the medical opinion may include, but is not limited to, a summary of the anonymous request for the medical opinion, a proposed diagnosis, whether the at least one anonymous medical professional agrees with the current diagnosis, details of a proposed treatment for the proposed diagnosis, questions to ask a treating physician, and education information, which may include attachments or links to educational content, for user 42 to review in order to understand more about the proposed diagnosis and possible treatments thereof. Additional information may be provided in the anonymous response associated with the anonymous request for the medical opinion. Medical opinion process 10 may save the anonymous response associated with the anonymous request for the medical opinion to database 100 for display on the web-based application for review by other users. For example, users may read the anonymous response associated with the anonymous request for the medical opinion via the at least one link to a recent response (e.g., “View a recent response” 308) from landing page 300.

In an embodiment, medical opinion process 10 may provide 206 the anonymous response associated with the anonymous request for the medical opinion to the user. Medical opinion process 10 may provide 206 the anonymous response associated with the anonymous request for the medical opinion from an operating client electronic device (e.g., operating client electronic device 28, 30, 32) associated with the at least one anonymous medical professional (e.g., user 36, 38, 40) to operating client electronic device 34 associated with user 42 over network 14, 18. Providing 206 the anonymous response associated with the anonymous request for the medical opinion to the user may include providing 206 the anonymous response associated with the anonymous request for the medical opinion to the user via an electronic reply, including emailing the anonymous response to the email address associated with the user. For example, user 42 may receive an email (not shown) with a standard message that reveals no personal or identifying information about user 42 or the anonymous medical professional that reviewed the anonymous request. The email may include the anonymous response. Additionally, the email may include a link to review the anonymous response via the web-based application at results page 900. The link to review the anonymous response via results page 900 may remain active for a defined period of time. Results page 900 may include a link to review the anonymous response online (e.g., “View Results Online” 902), a link to download the anonymous response as a PDF or other document (e.g., “Download as PDF” 904), and/or a link to email the anonymous response to a specified email address (e.g., “Email Results” 906).

Medical opinion process 10 may include at least one advertisement in the electronic reply to the user. The at least one anonymous medical professional reviewing the anonymous request for the medical opinion may include targeted advertising associated with the medical condition, proposed diagnosis, and/or treatment to include in the electronic reply to the user. Medical opinion process 10 may automatically include targeted advertising associated with the medical condition in the electronic reply based upon an automated algorithm, using input parameters including, but not limited to, the medical condition, proposed diagnosis, and treatment. In this manner, the at least one advertisement may be specifically targeted to the user. The at least one advertisement may also include general advertising for all users.

Medical opinion process 10 may further delete 210 the medical records associated with the anonymous request for the medical opinion once the anonymous response associated with the anonymous request for the medical opinion is provided to the user. In this manner, medical opinion process 10 may not retain any information regarding the anonymous request for the medical opinion within database 100. As discussed, medical opinion process 10 may save the anonymous response associated with the anonymous request for the medical opinion for display on the web-based application for review by other users, via “View a recent response” 308 from landing page 300. Medical opinion process 10 may restrict communication between the user and the at least one anonymous medical professional such that the user may not contact the at least one anonymous medical professional for further information or inquiries. For example, the reply functionality may be disabled from the received email including the anonymous response such that user 42 may not reply to the received email.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method, executing on one or more computing devices, comprising:
receiving, at the one or more computing devices, an anonymous request for a medical opinion by a user;
providing, using the one or more computing devices, the anonymous request for the medical opinion to at least one anonymous medical professional;
receiving, at the one or more computing devices, an anonymous response associated with the anonymous request for the medical opinion based upon, at least in part, review of the anonymous request for the medical opinion by the at least one anonymous medical professional; and
providing, using the one or more computing devices, the anonymous response associated with the anonymous request for the medical opinion to the user.

2. The computer-implemented method of claim 1, wherein the anonymous request for the medical opinion includes an inquiry associated with a medical condition.

3. The computer-implemented method of claim 1, wherein receiving the anonymous request for the medical opinion includes receiving medical records associated with the anonymous request for the medical opinion.

4. The computer-implemented method of claim 3, wherein the medical records associated with the anonymous request for the medical opinion includes at least one of: at least one symptom, a medical history, a current diagnosis, an existing treatment plan, at least one medical test result, and at least one medical image.

5. The computer-implemented method of claim 4, wherein at least one of the at least one medical test result and the at least one medical image includes user identifying demographic data.

6. The computer-implemented method of claim 5, further comprising:
obfuscating the user identifying demographic data within at least one of the at least one medical test result and the at least one medical image.

7. The computer-implemented method of claim 1, wherein the anonymous response associated with the anonymous request for the medical opinion includes at least one of: a proposed diagnosis, a proposed treatment, and educational information associated with the anonymous request for the medical opinion.

8. The computer-implemented method of claim 3, further comprising:
deleting the medical records associated with the anonymous request for the medical opinion after providing the anonymous response associated with the anonymous request for the medical opinion to the user.

9. The computer-implemented method of claim 1, wherein the at least one anonymous medical professional is included within a panel of a plurality of identified medical professionals.

10. The computer-implemented method of claim 2, wherein the at least one anonymous medical professional specializes in the medical condition.

11. A computer program product residing on a non-transitory computer readable storage medium having a plurality of instructions stored thereon, which when executed by a processor, cause the processor to perform operations comprising:
receiving an anonymous request for a medical opinion by a user;
providing the anonymous request for the medical opinion to at least one anonymous medical professional;
receiving an anonymous response associated with the anonymous request for the medical opinion based upon, at least in part, review of the anonymous request for the medical opinion by the at least one anonymous medical professional; and
providing the anonymous response associated with the anonymous request for the medical opinion to the user.

12. The computer program product of claim 11, wherein the anonymous request for the medical opinion includes an inquiry associated with a medical condition.

13. The computer program product of claim 11, wherein receiving the anonymous request for the medical opinion includes receiving medical records associated with the anonymous request for the medical opinion.

14. The computer program product of claim 13, wherein the medical records associated with the anonymous request for the medical opinion includes at least one of: at least one symptom, a medical history, a current diagnosis, an existing treatment plan, at least one medical test result, and at least one medical image.

15. The computer program product of claim 14, wherein at least one of the at least one medical test result and the at least one medical image includes user identifying demographic data.

16. The computer program product of claim 15, further comprising:
obfuscating the user identifying demographic data within at least one of the at least one medical test result and the at least one medical image.

17. The computer program product of claim 11, wherein the anonymous response associated with the anonymous request for the medical opinion includes at least one of: a proposed diagnosis, a proposed treatment, and educational information associated with the anonymous request for the medical opinion.

18. The computer program product of claim 13, further comprising:
deleting the medical records associated with the anonymous request for the medical opinion after providing the anonymous response associated with the anonymous request for the medical opinion to the user.

19. The computer program product of claim 11, wherein the at least one anonymous medical professional is included within a panel of a plurality of identified medical professionals.

20. The computer program product of claim 12, wherein the at least one anonymous medical professional specializes in the medical condition.
